(19) United States
(12) Patent Application Publication
(10) Pub. No.: US 2026/0119222 A1
(43) Pub. Date: Apr. 30, 2026

(54) MIGRATION OF CONFIDENTIAL VIRTUAL MACHINES

(71) Applicant: Arm Limited, Cambridge (GB)

(72) Inventors: Guilhem Floréal BRYANT, Cambridge (GB); Mathias Sven Lucien Alain BROSSARD, Austin, TX (US); Djordje KOVACEVIC, Hitchin (GB); Gareth Rhys STOCKWELL, Cambridge (GB)

(21) Appl. No.: 18/926,568

(22) Filed: Oct. 25, 2024

(51) Int. Cl. G06F 9/455; G06F 21/62

(52) U.S. Cl. CPC G06F 9/45558; G06F 21/62; G06F 2009/4557

(57) ABSTRACT

A data processing apparatus is provided in which initial processing circuitry executes program instructions - each of the program instructions relating to one or more confidential virtual machines. Initial storage circuitry stores data pages belonging to the one or more confidential virtual machines. Management circuitry causes a migration of a migrating confidential virtual machine of the confidential virtual machines to subsequent processing circuitry so that a future execution of those of the program instructions associated with the migrating confidential virtual machine are executed by the subsequent processing circuitry instead of the initial processing circuitry. The management circuitry causes the migration by causing one of the data pages belonging to the migrating confidential virtual machine to be migrated from the initial storage circuitry to subsequent storage circuitry. Confidential access circuitry accesses the data pages belonging to the migrating confidential virtual machine to determine the one of the data pages. The data pages are unreadable by the management circuitry.

### TECHNICAL FIELD

The present disclosure relates to data processing and particularly the resilience of data processing circuits.

### DESCRIPTION

A virtual machine can be thought of as a set of virtual resources backed by a set of physical resources that may be shared with other virtual machines. Sometimes, it is necessary for the virtual machine to be migrated, by management circuitry, to a new set of physical resources (e.g. due to congestion). This process can be inefficient when the virtual machine in question is confidential such that, for instance, its data cannot be accessed by the management circuitry.

### SUMMARY

Viewed from a first example configuration, there is provided a data processing apparatus comprising: initial processing circuitry configured to execute program instructions, wherein each of the program instructions relate to one or more confidential virtual machines; initial storage circuitry configured to store data pages belonging to the one or more confidential virtual machines; management circuitry configured to cause a migration of a migrating confidential virtual machine of the confidential virtual machines to subsequent processing circuitry so that a future execution of those of the program instructions associated with the migrating confidential virtual machine are executed by the subsequent processing circuitry instead of the initial processing circuitry, wherein the management circuitry is configured to cause the migration by causing one of the data pages belonging to the migrating confidential virtual machine to be migrated from the initial storage circuitry to subsequent storage circuitry; and confidential access circuitry configured to access the data pages belonging to the migrating confidential virtual machine to determine the one of the data pages, wherein the data pages are unreadable by the management circuitry.

Viewed from a second example configuration, there is provided a data processing method comprising: executing program instructions, wherein each of the program instructions relate to one or more confidential virtual machines; storing, in initial storage circuitry, data pages belonging to the one or more confidential virtual machines; causing, by management circuitry, a migration of a migrating confidential virtual machine of the confidential virtual machines to subsequent processing circuitry so that a future execution of those of the program instructions associated with the migrating confidential virtual machine are executed by the subsequent processing circuitry instead of the initial processing circuitry, wherein the migration causes one of the data pages belonging to the migrating confidential virtual machine to be migrated from the initial storage circuitry to subsequent storage circuitry; and accessing, by confidential access circuitry, the data pages belonging to the migrating confidential virtual machine to determine the one of the data pages, wherein the data pages are unreadable by the management circuitry.

Viewed from a third example configuration, there is provided a system comprising: the data processing apparatus implemented in at least one packaged chip; at least one system component; and a board, wherein the at least one packaged chip and the at least one system component are assembled on the board.

Viewed from a fourth example configuration, there is provided a chip-containing product comprising the system, wherein the system is assembled on a further board with at least one other product component.

Viewed from a fifth example configuration, there is provided a non-transitory computer readable medium comprising a computer program configured, when executed by a computer to: access data pages belonging to a migrating confidential virtual machine to determine one of the data pages to be migrated from an initial storage circuitry to a subsequent storage circuitry so that the migrating confidential virtual machine can be executed on a subsequent processing circuitry instead of an initial processing circuitry; notify management circuitry of the one of the data pages to be migrated from an initial storage circuitry to a subsequent storage circuitry, wherein the one of the data pages is unreadable by the management circuitry.

### BRIEF DESCRIPTION OF THE DRAWINGS

The present invention will be described further, by way of example only, with reference to embodiments thereof as illustrated in the accompanying drawings, in which:

FIG. 1 illustrates an apparatus in accordance with some examples;

FIG. 2 shows an example of one of the hosts;

FIG. 3 shows an example of the memory;

FIG. 4 illustrates the migration process in more detail;

FIG. 5 shows an example, in the form of a flowchart, of how it can be determined when a move from live to cold migration should occur;

FIG. 6 illustrates an example attestation process that may be used with any of the examples illustrated previously;

FIG. 7 shows a similar attestation process in which attestation is performed on both the data processing unit (DPU) and the realm manager – both of which are examples of confidential access circuitry;

FIG. 8 shows a flowchart that illustrates a method of data processing in accordance with some examples;

FIG. 9 shows a flowchart that illustrates a method of data processing as may be executed by computer software that implements the realm manager;

FIG. 10 shows one or more packaged chips, with the apparatus/circuitry implemented on one chip or distributed over two or more of the chips.

### DESCRIPTION OF EXAMPLE EMBODIMENTS

Before discussing the embodiments with reference to the accompanying figures, the following description of embodiments is provided.

In accordance with one example configuration there is provided a data processing apparatus comprising: initial processing circuitry configured to execute program instructions, wherein each of the program instructions relate to one or more confidential virtual machines; initial storage circuitry configured to store data pages belonging to the one or more confidential virtual machines; management circuitry configured to cause a migration of a migrating confidential virtual machine of the confidential virtual machines to subsequent processing circuitry so that a future execution of those of the program instructions associated with the migrating confidential virtual machine are executed by the subsequent processing circuitry instead of the initial processing circuitry, wherein the management circuitry is configured to cause the migration by causing one of the data pages belonging to the migrating confidential virtual machine to be migrated from the initial storage circuitry to subsequent storage circuitry; and confidential access circuitry configured to access the data pages belonging to the migrating confidential virtual machine to determine the one of the data pages, wherein the data pages are unreadable by the management circuitry.

A virtual machine (VM) can be considered to be a type of execution environment in which applications reside and execute. To the perspective of the applications, they may be executing on a physical machine having its own physical resources. In practice, the physical resources are a ‘virtual’ perspective of a party of the physical system on which the virtual machine resides. Typically, virtual machines are managed by a hypervisor or other supervisory software that arbitrates the physical resources between the virtual machines and acts as a ‘go-between’ between the virtual machines and the physical machines. A confidential virtual machine (CVM) is a particular type of virtual machine in which the hypervisor may be treated as an untrusted entity. In particular, in these examples, despite the hypervisor allocating use of the storage circuitry (e.g. memory), the data pages provided by that storage circuitry that are owned by a CVM are not readable (e.g. they are not accessible) to the hypervisor. This could be achieved by the parts of the storage circuitry owned by the CVM being encrypted, or it could be enforced by the hypervisor being physically prevented from accessing parts of the storage circuitry that belong to CVMs. The data pages are therefore off-limits or blocked. It is sometimes necessary to migrate a virtual machine from executing on one physical device to another. This involves moving the data pages from initial storage circuitry that belongs to the initial processing circuitry to subsequent storage circuitry that belongs to the subsequent processing circuitry. This process can be performed live or cold. In a cold migration, execution of the virtual machine is paused, the data pages are moved across, and execution of the virtual machine is resumed on the subsequent processing circuitry. However, this process can be slow and can involve significant downtime for the virtual machine. Live migration helps with this in that data pages are moved while the virtual machine is running. Data pages may therefore need to be transmitted more than once. Note that a live migration does not require that the entire migration happens live – merely that part of the migration is live. A live migration can be more complicated in the case of a CVM because the hypervisor (that might ordinarily coordinate the migration) is unable to read the data belonging to the CVM. This therefore requires a periodic or repeated querying of the confidential access circuitry to assist in the transition. This in itself is inefficient because it requires periodic or repeated permission changes. The present technique helps with this situation by having the confidential access circuitry make the decision of which data pages should be migrated. The confidential access circuitry may also decide a priority of the pages to be migrated, as well as indicate when each page should be migrated. The confidential access circuitry might, for instance, form part of a realm management circuit (i.e. circuitry that manages confidential virtual machines) or even part of a data processing unit (DPU) or accelerator that provides specific I/O acceleration capabilities (e.g. for encryption, networking, and so on). In some cases, the confidential access circuitry may comprise both a realm management circuit and an accelerator.

In some examples, the management circuitry is configured to allocate the data pages to each of the confidential virtual machines. Although the management circuitry (e.g. a hypervisor) is not permitted to read pages that have been allocated to the confidential virtual machines (through either a physical prevention or through encryption), the management circuitry may still be responsible for allocating the data pages to the confidential virtual machines. One situation in which this may occur is where the management circuitry provides a confidential virtual machine with a portion of memory into which encrypted contents of the data pages belonging to that confidential virtual machine can be provided – so that the data pages can be migrated in an encrypted form.

In some examples, the data processing apparatus comprises: tracking circuitry configured to track which of the data pages has been prepared for migration to the subsequent storage circuitry and in response to the one of the data pages being changed after being prepared for migration, to cause an invalidation notification to be sent to the subsequent storage circuitry that the one of the data pages should be invalidated. Here, the tracking circuitry is able to determine whether a particular data page has been prepared for migration or not (e.g. that it has been encrypted ready to be sent to the new host). Consequently, if a given data page changed, it is possible to determine whether an invalidation of the data page should be sent. In particular, if a data page has been prepared for migration and then it changes, then an invalidation will be sent so that old data is not used. The actual monitoring of changes will typically be performed by the confidential access circuitry, which has the ability to read the data pages of the confidential virtual machines. Note that in some situations, a race condition may occur in which a data page is prepared for migration (e.g. encryption begins) and then the data page is changed. In this situation, if the preparation and migrating process is performed atomically (i.e. both happen together) then an invalidation will be sent. Otherwise, if the actual migration can be halted, then there is no need for the invalidation to be sent. Thus, even in these examples, it is not necessarily the case that an invalidation must always be sent following preparation for migration when a change occurs to the data page.

In some examples, the management circuitry comprises the tracking circuitry, and the management circuitry updates the tracking circuitry in response to a change notification from the confidential access circuitry. The tracking circuitry can be provided in a number of locations. However, in these examples, the tracking circuitry is provided as part of the management circuitry. Consequently, the confidential access circuitry will inform the management circuitry and the tracking circuitry that a page has changed and the management circuitry will cause any required invalidations to occur.

In some examples, the confidential access circuitry comprises the tracking circuitry and the notification is sent by requesting the management circuitry to send the invalidation notification. In these examples, the tracking circuitry is provided alongside the confidential access circuitry. This may be appropriate in examples where a larger portion of the migration process is handed off to the confidential access circuitry. In these situations, the invalidation notification is sent by the management circuitry by a request from the confidential access circuitry when the confidential access circuitry determines that such an invalidation request should be issued.

In some examples, in response to a determination that one or more criteria regarding migrating of the data pages belonging to the migrating confidential virtual machine from the initial storage circuitry to the subsequent storage circuitry have been met, the management circuitry is configured to halt the migrating confidential virtual machine and then to transfer remaining data pages belonging to the migrating confidential virtual machine to the subsequent storage circuitry. In these examples, the migration process changes from live to cold. The determination of when this occurs is based on some specified criteria. The cold migration involves halting the migrating confidential virtual machine and then any remaining data pages that have not yet been migrated (including those that have been migrated but are now invalidated - if any) are migrated to their new location. A signal can then be transmitted that the migration is complete and the migrating confidential virtual machine can be resumed up on its new host.

In some examples, the determination is made by the management circuitry. The management circuitry can therefore be responsible for deciding when the live migration has reached its conclusion.

In some examples, the determination is made by the confidential access circuitry. The confidential access circuitry can therefore be responsible for deciding when the live migration has reached its conclusion.

In some examples, the criteria comprise a number of those of the data pages belonging to the migrating confidential virtual machine that are changed after being prepared for migration to the subsequent storage circuitry. One way to determine when the live migration has reached its conclusion is to consider a number of the data pages that change after being prepared for migration. There are several ways in which this information can be used. For instance, if the number of such pages is high then the live migration might be stopped very quickly on the basis that many invalidations will need to be sent. In some examples, this number may be compared to the length of time that the migration has been going on for, or may consider a proportion of the data pages for which invalidations are being sent (a smaller proportion indicating that the live migration should continue).

In some examples, the criteria comprise a rate at which the number of those of the data pages belonging to the migrating confidential virtual machine that are changed after being prepared for migration to the subsequent storage circuitry, compared to a threshold. Rather than considering the number directly, the rate of change may be considered. For instance if the number of changed pages starts to increase, then this suggests that the live migration may need to be stopped since the easy to migrate pages have already been migrated. Obviously this will depend on the virtual machine itself and the rate at which data is changing – for instance, a virtual machine that only changes a small amount of data over a long time may be permitted to have a large number of pages transferred before cold migration takes over.

In some examples, the confidential access circuitry comprises confidential virtual machine management circuitry configured to manage a behaviour of the confidential virtual machines. The confidential virtual machine management circuitry may be partly responsible for managing the confidential virtual machines. For instance, it may be responsible or used in the creation of the confidential virtual machines or may fulfil other administrative roles that cannot be performed by the management circuitry (which may not be trusted).

In some examples, the confidential access circuitry comprises acceleration circuitry configured to determine the one of the data pages by reading the one of the data pages. The acceleration circuitry may take the form of a data processing unit (DPU), which is able to accelerate particular I/O tasks that are offloaded by a main CPU, performed by the DPU, and a result sent back to the CPU. A DPU may include circuitry that accelerates tasks including any number of compression, storage, cryptography, and networking for instance. Meanwhile, the DPU may be able to perform direct memory access (DMA) to the initial storage circuitry and may be trusted by the confidential access circuitry to read the data pages used by the confidential access circuitry. Note that the confidential access circuitry could not only include a DPU but the confidential access circuitry could be the DPU.

In some examples, the confidential virtual machine management circuitry is configured to perform an attestation process to determine an authenticity of the acceleration circuitry. The attestation process could involve verifying that the vendor of particular hardware is correct (e.g. as expected) and may additionally or alternatively include verifying that the configuration of a particular device is correct. This can be achieved using a combination of checksums (e.g. hashes), digital signing, and trusted computing. For instance, a hash or checksum of an execution environment could be performed by software running in an unmodifiable, unreadable trusted execution environment on a device – with the result being signed by an unreadable private key held in the trusted execution environment to help ensure its correctness. This could be provided to another entity to confirm that the configuration and vendor is as expected. Alternatively, these checks could be performed by the trusted execution environment itself, and a result returned (signed) to indicate that everything is as it should be. With the trusted execution environment being unreadable and unmodifiable, the signing process cannot be interfered with. By attesting to the acceleration circuitry, it is possible to allow the acceleration circuitry to be trusted (e.g. to access the data pages of the confidential virtual machines). Note that within this document, the scope of the attestation is not strictly defined. For instance, the attestation could be to the hardware, the firmware, software running on the hardware, and so on, as required to enable an appropriate degree of trust to be established. In general, this may depend on the extent to which trust is distributed. For instance, if the firmware already performs attestation on the hardware and the underlying execution environment then it may be sufficient to perform attestation only on the firmware itself.

In some examples, the confidential virtual machine management circuitry is configured to respond to an attestation request from the acceleration circuitry by performing an attestation process on the confidential virtual machine management circuitry. The attestation process may also work both ways. For instance the acceleration circuitry may require attestation of the confidential virtual machine management circuitry to ensure that it is not being asked to perform tasks illegitimately.

In some examples, at least one of the confidential virtual machine management circuitry and the acceleration circuitry is configured to perform an attestation process on the subsequent processing circuitry or a subsequent data processing apparatus comprising the subsequent processing circuitry. Further attestation that can be performed is in respect of the subsequent processing circuitry or data processing apparatus containing the subsequent processing circuitry. This could include attestation of the hypervisor, the hardware, the realm domain in which the confidential access circuitry may reside, the firmware of any of these components and so on as explained above.

In some examples, the confidential access circuitry is configured to perform an attestation process on the subsequent processing circuitry or a subsequent data processing apparatus comprising the subsequent processing circuitry. The attestation may thusly be performed either by, e.g. a realm manager, or a DPU, or both devices. This is regardless of whether a DPU is provided in addition to or instead of realm management. Note that in situations where both a DPU and a realm manager are provided, the DPU may be permitted to perform attestation only after the DPU itself has undergone its own attestation to the realm manager.

Particular embodiments will now be described with reference to the figures.

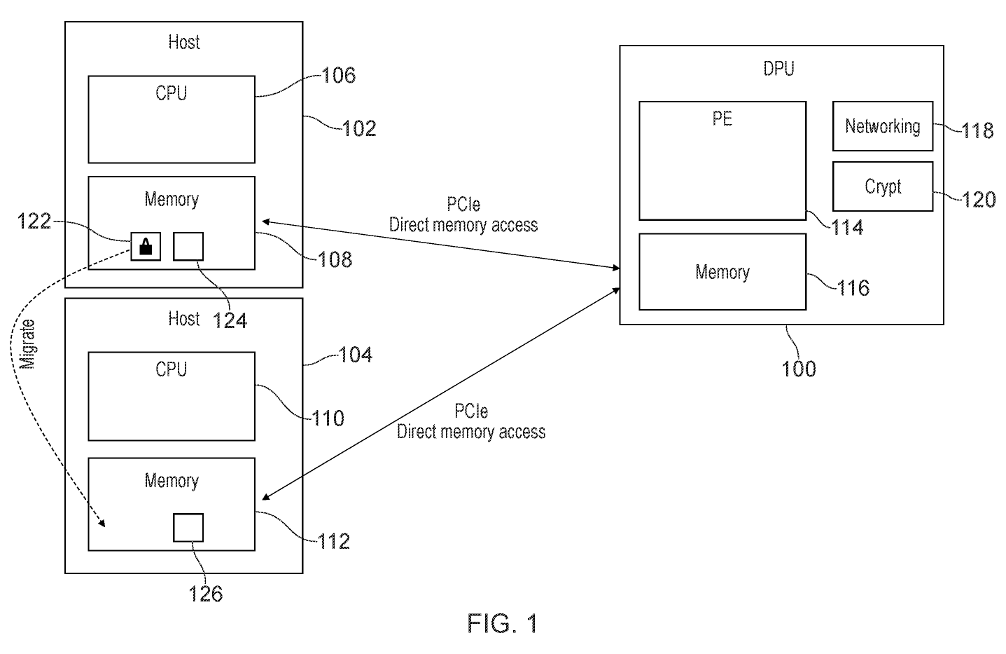

FIG. 1 illustrates an apparatus 100 in accordance with some examples. In these examples, the apparatus takes the form of a Data Processing Unit (DPU), which can be thought of as a piece of hardware with some I/O acceleration capability. Here, the DPU is shown to have dedicated circuitry for performing networking 118 and encryption 120 for instance. The DPU may be accessible via a PCIe bus, for instance. Here, the DPU 100 is shown to have its own processing element (PE) 114 and its own memory 116 – although this may not always be the case.

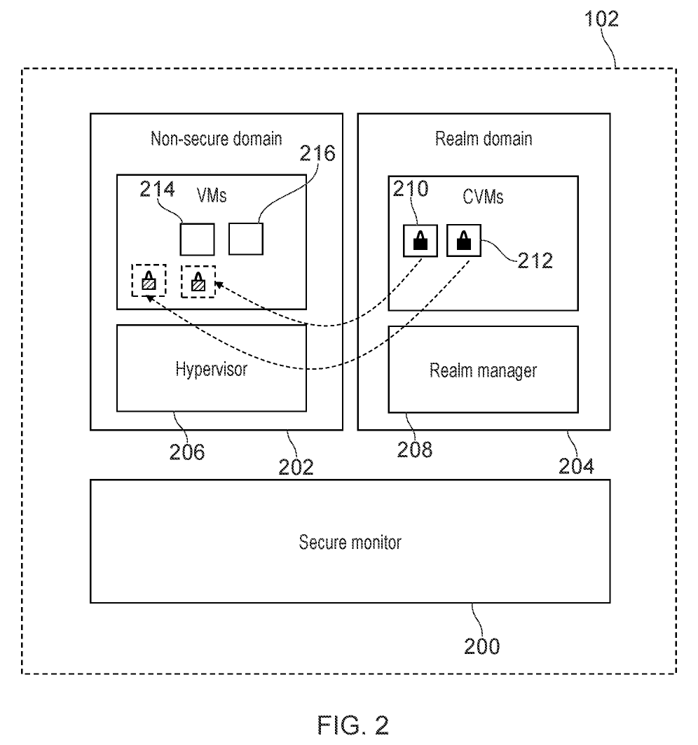

In this example, there are a number of virtual machines (VMs) 122, 124 that execute on a CPU 106 of a host 102. The VMs 122, 124 are resident within a memory 108 associated with the CPU 106. Here, the virtual machine 122 is to be migrated so that it is executed on the CPU 110 of another host 104 having another memory 112 on which another virtual machine 126 is stored. Also in this example, the migrating virtual machine 122 is a confidential virtual machine so that the hypervisor (shown in FIG. 2), although ultimately responsible for scheduling the confidential virtual machine 122, is unable to access the memory belonging to that virtual machine 122. This lack of access may be through encryption or may be through physical access control.

The DPU 100 has direct memory access (DMA) to the memory 108 of the first host 102 and the memory 112 of the subsequent host 104. In particular, the DPU 100 can access the memory belonging to confidential virtual machine 122.

The migration of a virtual machine can be ‘live’ or ‘cold’. In a live migration, the virtual machine keeps running while memory is copied to the new location. In a cold migration, the virtual machine is shut down before the copying takes place. In a live migration, a problem that occurs is that the memory will continually change. Consequently, memory that has already been copied may have to be invalidated and copied again. At some point, it may be considered to be no longer worthwhile continuing with a live migration and so the live migration may move to a cold migration to copy the remaining pages without risk of those pages being changed.

FIG. 2 shows an example of one of the hosts 102. Notionally, there are a pair of execution environments under which virtual machines execute. Although these different execution environments may involve a physical separation of hardware, they are generally used to describe the behaviour or way in which the virtual machines are treated.

In a non-secure domain 202, ordinary virtual machines execute 214, 216 under the supervision of the hypervisor 206. Note that ‘non-secure’ is not intended to be interpreted as ‘insecure’, but rather that the domain 202 is not a so called ‘secure domain’, which may be reserved for, for instance, the manufacturer of the hardware to use. Each of the virtual machines 214, 216 is allocated a share of physical resources (such as the CPU 106 and memory 108) to use in executing that virtual machine 214, 216. The virtual machines 214, 216 are generally unaware of each other – resources that are allocated to other virtual machines are not identified or addressable by other virtual machines and so the memory is segmented. The hypervisor 206, which is responsible for controlling the use of the physical resources, may be able to read the memory used by one of these virtual machines 214, 216.

In contrast, a realm domain 204 also exists. The realm domain 204 is an execution environment in which access to its virtual machines 210, 212 known as confidential virtual machines (CVMs) is prohibited to the hypervisor 206. That is, the hypervisor 206 is able to allocate resources such as memory 108, 122 but thereafter is unable to see the contents of that memory, which may be used by the confidential virtual machines 210, 212. Consequently the realm domain may be used by software providers that do not trust supervisory software running on the device such as the hypervisor 206. Note that in this situation, the hypervisor 206 is unable to access the memory used by the confidential virtual machines 210, 212 but is still responsible for those virtual machines 210, 212. It is not only aware of their existence, but is able to allocate resources, schedule the confidential virtual machines 210, 212, stop them, start them, and so on. The CVMs 210, 212 are also managed by a realm manager 208, which may be jointly responsible for creating the CVMs 210, 212, registering them, and so on. The realm manager is able to read the memory used by each of the CVMs 210, 212.

The realm manager 208 is an example of the claimed confidential access circuitry. The DPU 100 is a further example. In some situations, both a realm manager 208 and the DPU may exist, and one or both of these may be the claimed confidential access circuitry.

A secure monitor 200 is also provided. The secure monitor may run at the highest level of privilege on the device and is responsible for controlling the privilege level.

As previously explained, difficulties can arise when a CVM 210 is to be migrated. In particular, the hypervisor 206 is unable to access pages to memory that have been allocated to a CVM 210. One way of solving this is to have the realm manager 208 encrypt the page, to pass to the hypervisor, to then migrate to the new host. This, however, requires a degree of back-and-forth between the hypervisor 206 and the realm manager 208, which in turn requires requests for permission changes to be sent to the secure monitor 200. Still furthermore, it is difficult for the hypervisor to track which pages need sending again (or invalidating) since the hypervisor may not even be able to determine that a memory page has changed. This may require still further assistance from the realm manager 202 or other confidential access circuitry, which in turn makes use of the secure monitor 200. The frequent switching between these execution environments can be inefficient.

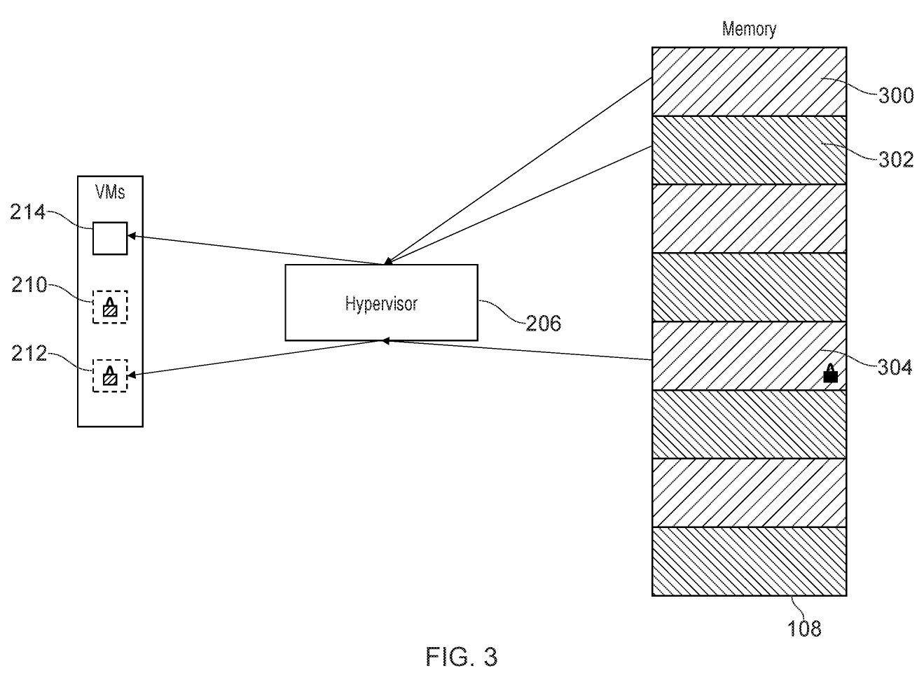

FIG. 3 shows an example of the memory 108. Here, the hypervisor 206 is able to allocate to virtual machines. For instance, two pages 300, 302 may be allocated to a virtual machine 214, or one page 304 may be allocated to a virtual machine 212 or no pages may be allocated to a virtual machine 210. Regardless, pages 304 that are allocated to a confidential virtual machine 212 are not accessible by the hypervisor 206.

The present technique helps to resolve this problem by allowing the confidential access circuitry (e.g. the DPU 100 and/or the realm manager 208) to determine the memory page that is to be migrated to the new/subsequent host 104.

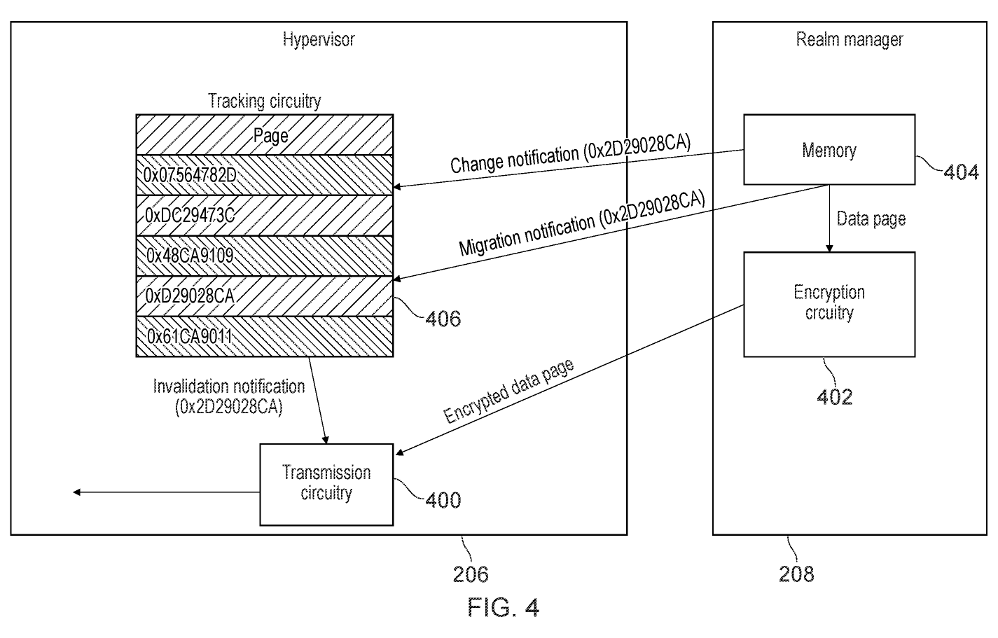

FIG. 4 illustrates this process in more detail. Here, the hypervisor 206 uses tracking circuitry 406 to track particular pages of memory that have started the preparation process for transmission to the new host 104. The confidential access circuitry 208 determines when/which page belonging to a CVM 212 should next be migrated and notifies the hypervisor 206. The hypervisor then stores the page identifier (e.g. the address) in the tracking circuitry 406. In addition, the page is encrypted using encryption circuitry 402 that is accessible to the realm manager 208. The encryption is such that the hypervisor cannot decrypt the page. The encrypted data page is then sent to the transmission circuitry 400, which transmits the page to the new host 104. When a page is changed, as detected by the confidential access circuitry 208 (e.g. using dirty bits), a notification is sent to the hypervisor 206. If the page has already been transmitted (as indicated in the tracking circuitry) then an invalidation notification is sent to the transmission circuitry 400 to send an invalidation request to the new host 104 to invalidate the copy of the page that was already migrated. If the page has not been prepared for migration then no action needs to be taken.

Note that in practice, if the preparation process for a page has begun but has not yet been completed (e.g. the encryption has not been completed, or the encrypted page has not yet been sent) then the invalidation can be foregone and the migration of that page can simply be cancelled.

There are a number of other ways in which the migration process can be handled for which the present technique can also be applied. For instance, in this example, the tracking circuitry 406 forms part of the hypervisor 206 since the migration process will generally involve the hypervisor as the authority over the local hardware. However, the tracking circuitry 406 could also be part of the confidential access circuitry (e.g. the realm manager 208 or the DPU 100). In this case, the hypervisor may simply instruct the confidential access circuitry to perform the migration and then transmit encrypted data pages that are passed to it. The process of deciding which pages to migrate then remains the job of the realm manager 208. In any of these examples, the realm manager 208 could perform the migration itself, or could delegate this task to a DPU 100. Furthermore, the migration could be directly to a new host 104, which could itself be a DPU. As a still further variant, the new host 104 might not be a DPU, but a DPU could be used at the new host 104 to perform decryption of encrypted memory pages.

The actual process for selecting a memory page is not relevant to the present technique. In some cases, the page may be selected randomly, or may be selected based on a least recently used measurement (provided such data exists or can be obtained, e.g. through monitoring over a period).

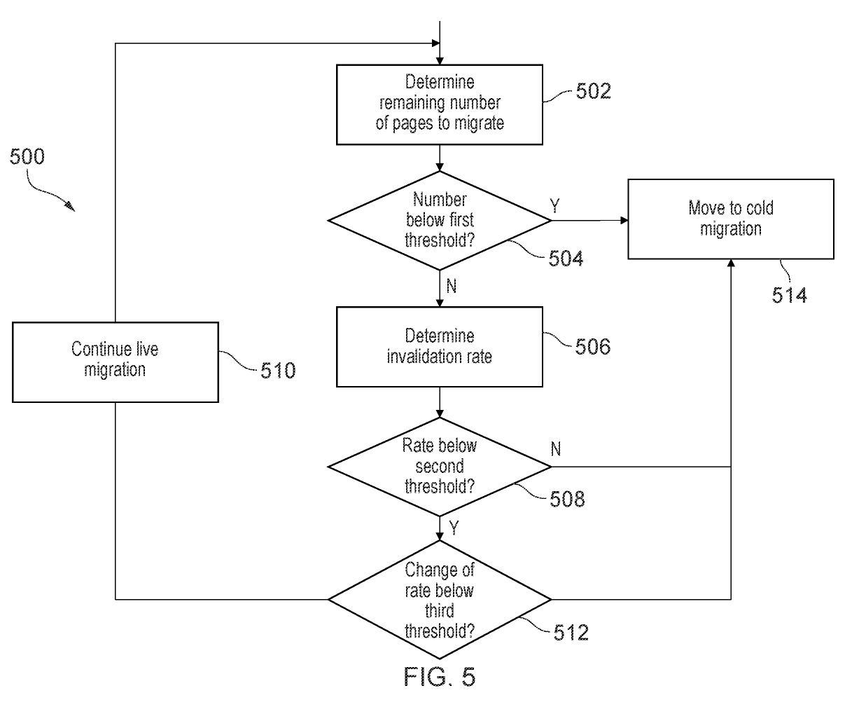

FIG. 5 shows an example, in the form of a flowchart, of how it can be determined when a move from live to cold migration should occur. The process begins at a step 502 where it is determined or estimated how many more memory pages of a migrating CVM 212 are remaining to be migrated. At step 504, it is determined whether that number is below a first threshold. If so, then at step 514 the migration proceeds in a cold form because the amount of down time of the CVM 212 is considered to be very low. Alternatively, at step 506, the invalidation rate is determined. This is the rate at which invalidations are being sent because pages are changing after being migrated. If the rate is above a second threshold then too many invalidations are occurring and so the process may be considered to proceed more efficiently be proceeding with cold migration (step 514). Alternatively, it is determined whether the change of rate is below a third threshold – in other words, is the rate of invalidation slowing down or speeding up? If the rate is above a third threshold then cold migration occurs at step 514. For instance, if pages are changing faster then they are being invalidated then cold migration occurs. Otherwise, the live migration continues and the process returns to step 502. This process may be executed periodically.

It may be desirable to verify the authenticity of the subsequent (receiving) host and/or any DPU to which (a part of) the migration process is offloaded. In addition, it may be desirable for either of the DPU or the subsequent (receiving) host to verify an authenticity of the sending host. This verification may not only include verifying that the device was produced by a recognised and/or trusted manufacturer, but also that the current configuration of the device matches an acceptable configuration.

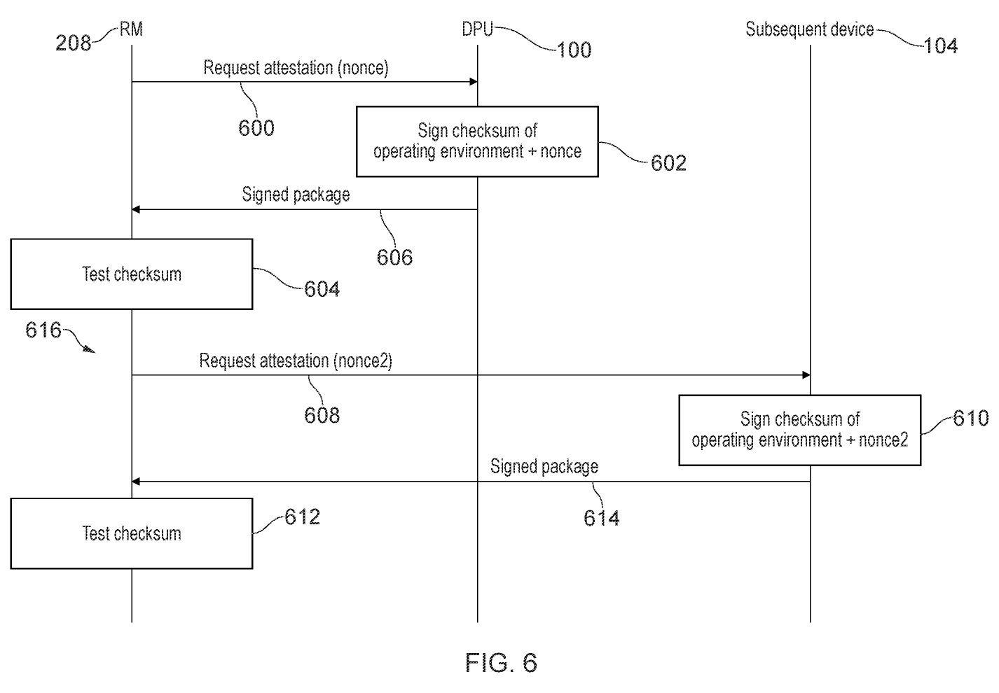

FIG. 6 illustrates an example attestation process that may be used with any of the examples illustrated previously (or indeed, other examples not explicitly described). In this example, the realm manager 208 performs attestation on both a DPU 100 and a receiving host/subsequent device 104 to verify their authenticity before beginning the migration process.

The realm manager (RM) 208 starts by generating a nonce (number used once). This can be a random or pseudo random number for instance. The nonce is transmitted at step 600 from the RM 208 to the DPU 100 as part of an attestation request. This is received by the DPU 100. Read-only software on the DPU 100 then executes at step 602 to produce a checksum or hash of the operating environment. This can include any number of the hardware, the firmware, or parts of the execution environments. The process of generating the checksum or hash is not accessible to other software running on the device. For instance, it may run in a ‘secure’ or ‘root’ domain on the device, which is isolated from the other domains 202, 204. The checksum or hash that is generated is then signed (together with the nonce) and the resulting package is transmitted at step 606 back to the RM 208. The signing key would be expected to reside in a location in which other non-manufacturer software cannot run and therefore should remain inaccessible to anyone but the manufacturer. The nonce prevents a replay attack from taking place by repeatedly providing the same signed package. The checksum is tested at a step 604 against a set of known, allowable checksums or hashes (or alternatively a set of disallowed checksums or hashes) to determine whether the configuration and/or execution environments match what is permitted. If not then the attestation fails. This can result in either no response being provided or a negative response being provided to the original request. The realm manager 208 may also check that the nonce is the same as the one that was sent out. Again, a mismatch here would indicate a failed attestation process. Provided these tests are met, attestation of the DPU 100 by the realm manager 208 is considered to be successful.

In this example, further attestation is then requested for the subsequent circuitry 104. This process begins by the generation of a second nonce at step 608. A similar process is then used in which the checksum of the operating environment of the subsequent device 104 is signed (together with the second nonce) at step 610 and returned at step 614 for checking at the realm manager 208 at step 612.

It will be appreciated that there are other ways in which attestation can be performed using cryptography. For instance, the checking of the operating environment may be carried out entirely by the realm manager 208.

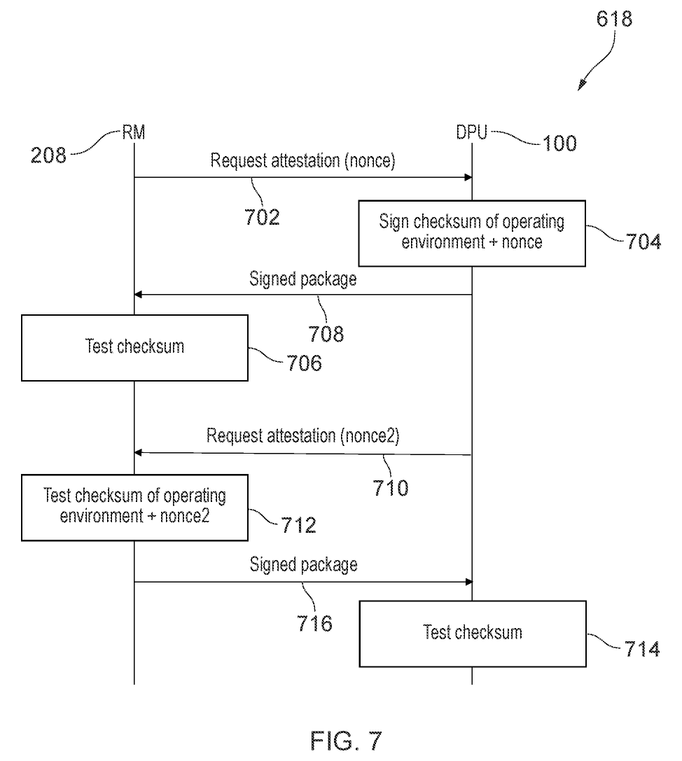

FIG. 7 shows a similar attestation process in which attestation is performed on both the DPU 100 and the realm manager 208. At step 702, an attestation request is made from the realm manager 208 to the DPU 100, and the request contains a nonce. A checksum is generated and signed at step 704 (together with the nonce) and the result is returned at step 708. The result is then checked (as previously described) at step 706. Here, however, the DPU 100 then requests attestation of the realm manager 208. This is achieved by reversing the process. In particular, the DPU 100 generates a nonce (nonce 2) and then transmits this in an attestation request at step 710. A checksum of the execution environments related to the realm manager 208 is then generated. This can include the firmware as before, but may also include a checksum of any realm management software. Regardless, these checksums are signed (together with nonce2) at step 712 and returned at step 716. The DPU 100 then performs its own signature and nonce checking to ensure that the returned data is appropriate and correct at step 714.

It will be appreciated that a similar mechanism can be used between the receiving/subsequent host 104 and either or both of the DPU 100 and realm manager 208.

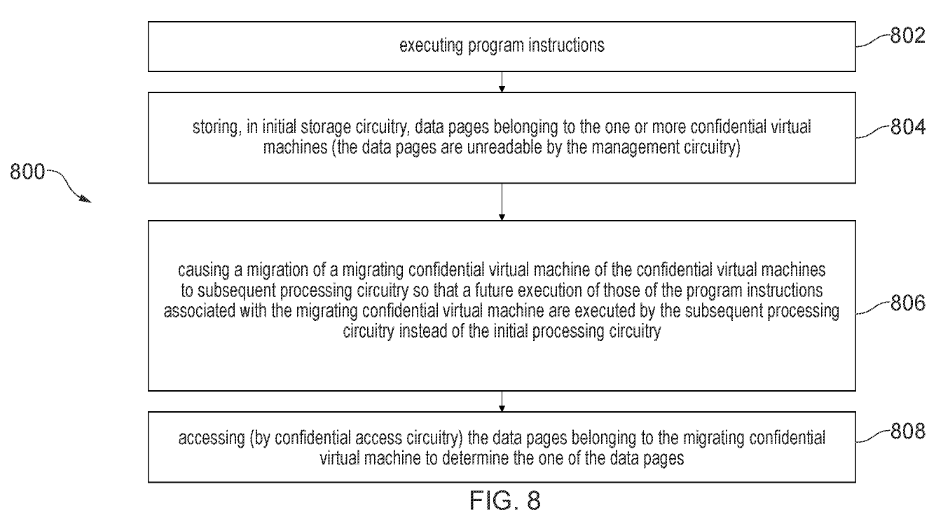

FIG. 8 shows a flowchart 800 that illustrates a method of data processing in accordance with some examples. At step 802, program instructions are executed. At a step 804, confidential virtual machines (whose access to memory pages is strictly controlled) are stored in an initial storage circuitry. At a step 806, a migration process is caused by management circuitry (which cannot access the confidential memory pages). This means that future execution of the confidential virtual machine takes place on a subsequent processing circuitry rather than the initial processing circuitry on which the virtual machine previously executes. Then at step 808, confidential access circuitry (i.e. not the management circuitry), which is able to access the memory pages belonging to the confidential virtual machine, is used to access the memory pages in order to determine a data page belonging to a confidential virtual machine to be migrated that should be migrated.

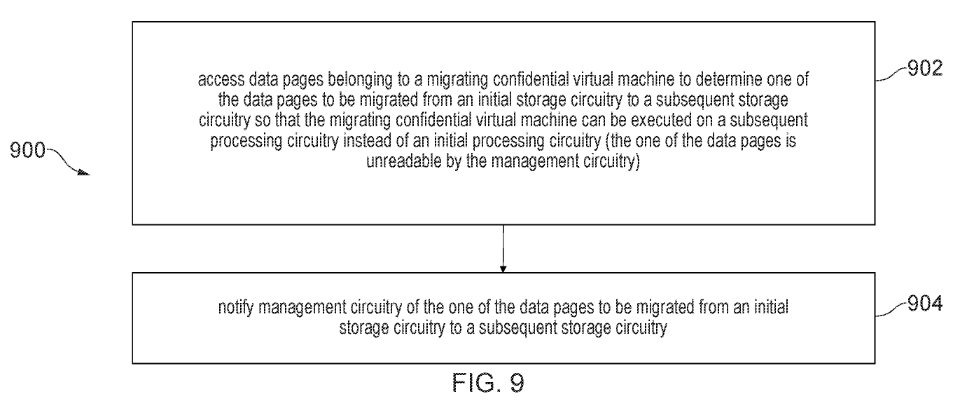

FIG. 9 shows a flowchart 900 that illustrates a method of data processing as may be executed by computer software that implements the realm manager. At a step 902, data pages belonging to a migrating confidential virtual machine are accessed to determine one of the data pages to be migrated from an initial storage circuitry to a subsequent storage circuitry so that the migrating confidential virtual machine can be executed on a subsequent processing circuitry instead of an initial processing circuitry. This may be performed in response to a request from management circuitry (which cannot access the data pages) either to select a specific page, or to perform the migration process and provide multiple data pages to migrate. Then at a step 904, the management circuitry is notified of the data page(s) to be migrated. This notification may be accompanied by an encrypted version of the page(s) that have been signed by an encryption key for which the management circuitry does not have the corresponding decryption key. The receiving/subsequent host (or a specific part of it) may have the corresponding decryption key so that the encrypted data pages can be decrypted.

Concepts described herein may be embodied in a system comprising at least one packaged chip. The apparatus and/or circuitry described earlier is implemented in the at least one packaged chip (either being implemented in one specific chip of the system, or distributed over more than one packaged chip). The at least one packaged chip is assembled on a board with at least one system component. A chip-containing product may comprise the system assembled on a further board with at least one other product component. The system or the chip-containing product may be assembled into a housing or onto a structural support (such as a frame or blade).

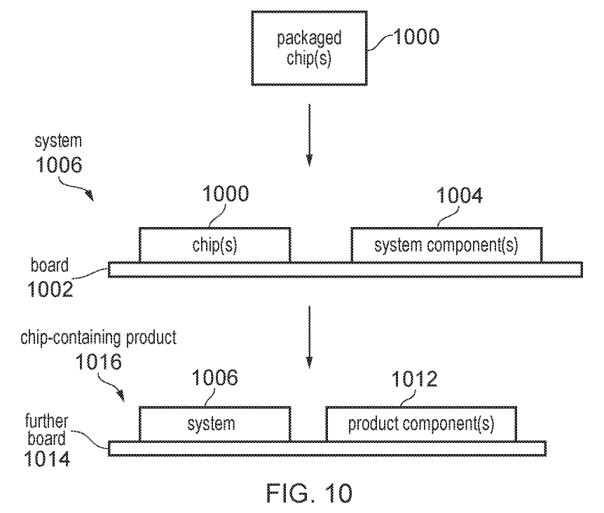

As shown in FIG. 10, one or more packaged chips 1000, with the apparatus/circuitry described above implemented on one chip or distributed over two or more of the chips, are manufactured by a semiconductor chip manufacturer. In some examples, the chip product 1000 made by the semiconductor chip manufacturer may be provided as a semiconductor package which comprises a protective casing (e.g. made of metal, plastic, glass or ceramic) containing the semiconductor devices implementing the apparatus/circuitry described above and connectors, such as lands, balls or pins, for connecting the semiconductor devices to an external environment. Where more than one chip 1000 is provided, these could be provided as separate integrated circuits (provided as separate packages), or could be packaged by the semiconductor provider into a multi-chip semiconductor package (e.g. using an interposer, or by using three-dimensional integration to provide a multi-layer chip product comprising two or more vertically stacked integrated circuit layers).

In some examples, a collection of chiplets (i.e. small modular chips with particular functionality) may itself be referred to as a chip. A chiplet may be packaged individually in a semiconductor package and/or together with other chiplets into a multi-chiplet semiconductor package (e.g. using an interposer, or by using three-dimensional integration to provide a multi-layer chiplet product comprising two or more vertically stacked integrated circuit layers).

The one or more packaged chips 1000 are assembled on a board 1002 together with at least one system component 1004 to provide a system 406. For example, the board may comprise a printed circuit board. The board substrate may be made of any of a variety of materials, e.g. plastic, glass, ceramic, or a flexible substrate material such as paper, plastic or textile material. The at least one system component 1004 comprise one or more external components which are not part of the one or more packaged chip(s) 1000. For example, the at least one system component 1004 could include, for example, any one or more of the following: another packaged chip (e.g. provided by a different manufacturer or produced on a different process node), an interface module, a resistor, a capacitor, an inductor, a transformer, a diode, a transistor and/or a sensor.

A chip-containing product 1016 is manufactured comprising the system 1006 (including the board 1002, the one or more chips 1000 and the at least one system component 1004) and one or more product components 1012. The product components 1012 comprise one or more further components which are not part of the system 1006. As a non-exhaustive list of examples, the one or more product components 1012 could include a user input/output device such as a keypad, touch screen, microphone, loudspeaker, display screen, haptic device, etc.; a wireless communication transmitter/receiver; a sensor; an actuator for actuating mechanical motion; a thermal control device; a further packaged chip; an interface module; a resistor; a capacitor; an inductor; a transformer; a diode; and/or a transistor. The system 1006 and one or more product components 1012 may be assembled on to a further board 1014.

The board 1002 or the further board 1014 may be provided on or within a device housing or other structural support (e.g. a frame or blade) to provide a product which can be handled by a user and/or is intended for operational use by a person or company.

The system 1006 or the chip-containing product 1016 may be at least one of: an end-user product, a machine, a medical device, a computing or telecommunications infrastructure product, or an automation control system. For example, as a non-exhaustive list of examples, the chip-containing product could be any of the following: a telecommunications device, a mobile phone, a tablet, a laptop, a computer, a server (e.g. a rack server or blade server), an infrastructure device, networking equipment, a vehicle or other automotive product, industrial machinery, consumer device, smart card, credit card, smart glasses, avionics device, robotics device, camera, television, smart television, DVD players, set top box, wearable device, domestic appliance, smart meter, medical device, heating/lighting control device, sensor, and/or a control system for controlling public infrastructure equipment such as smart motorway or traffic lights.

The present disclosure could be configured as follows:

1. A data processing apparatus comprising:

initial processing circuitry configured to execute program instructions, wherein each of the program instructions relate to one or more confidential virtual machines;

initial storage circuitry configured to store data pages belonging to the one or more confidential virtual machines;

management circuitry configured to cause a migration of a migrating confidential virtual machine of the confidential virtual machines to subsequent processing circuitry so that a future execution of those of the program instructions associated with the migrating confidential virtual machine are executed by the subsequent processing circuitry instead of the initial processing circuitry, wherein the management circuitry is configured to cause the migration by causing one of the data pages belonging to the migrating confidential virtual machine to be migrated from the initial storage circuitry to subsequent storage circuitry; and

confidential access circuitry configured to access the data pages belonging to the migrating confidential virtual machine to determine the one of the data pages, wherein

the data pages are unreadable by the management circuitry.

2. The data processing apparatus according to clause 1, wherein

the management circuitry is configured to allocate the data pages to each of the confidential virtual machines.

3. The data processing apparatus according to any preceding clause, comprising:

tracking circuitry configured to track which of the data pages has been prepared for migration to the subsequent storage circuitry and in response to the one of the data pages being changed after being prepared for migration, to cause an invalidation notification to be sent to the subsequent storage circuitry that the one of the data pages should be invalidated.

4. The data processing apparatus according to clause 3, wherein

the management circuitry comprises the tracking circuitry, and the management circuitry updates the tracking circuitry in response to a change notification from the confidential access circuitry.

5. The data processing apparatus according to clause 3, wherein

the confidential access circuitry comprises the tracking circuitry and the invalidation notification is sent by requesting the management circuitry to send the invalidation notification.

6. The data processing apparatus according to any preceding clause, wherein

in response to a determination that one or more criteria regarding migrating of the data pages belonging to the migrating confidential virtual machine from the initial storage circuitry to the subsequent storage circuitry have been met, the management circuitry is configured to shut down the migrating confidential virtual machine and then to transfer remaining data pages belonging to the migrating confidential virtual machine to the subsequent storage circuitry.

7. The data processing apparatus according to clause 6, wherein

the determination is made by the management circuitry.

8. The data processing apparatus according to clause 6, wherein

the determination is made by the confidential access circuitry.

9. The data processing apparatus according to any one of clauses 6-8, wherein

the criteria comprise a number of those of the data pages belonging to the migrating confidential virtual machine that are changed after being prepared for migration to the subsequent storage circuitry.

10. The data processing apparatus according to any one of clauses 6-9, wherein

the criteria comprise a rate at which the number of those of the data pages belonging to the migrating confidential virtual machine that are changed after being prepared for migration to the subsequent storage circuitry, compared to a threshold.

11. The data processing apparatus according to any preceding clause, wherein

the confidential access circuitry comprises confidential virtual machine management circuitry configured to manage a behaviour of the confidential virtual machines.

12. The data processing apparatus according to clause 11, wherein

the confidential access circuitry comprises acceleration circuitry configured to determine the one of the data pages by reading the one of the data pages.

13. The data processing apparatus according to clause 12, wherein

the confidential virtual machine management circuitry is configured to perform an attestation process to determine an authenticity of the acceleration circuitry.

14. The data processing apparatus according to any one of clauses 12-13, wherein

the confidential virtual machine management circuitry is configured to respond to an attestation request from the acceleration circuitry by performing an attestation process on the confidential virtual machine management circuitry.

15. The data processing apparatus according to any one of clauses 12-14, wherein

at least one of the confidential virtual machine management circuitry and the acceleration circuitry is configured to perform an attestation process on the subsequent processing circuitry or a subsequent data processing apparatus comprising the subsequent processing circuitry.

16. The data processing apparatus according to any preceding clause, wherein

the confidential access circuitry is configured to perform an attestation process on the subsequent processing circuitry or a subsequent data processing apparatus comprising the subsequent processing circuitry.

17. A data processing method comprising:

executing program instructions, wherein each of the program instructions relate to one or more confidential virtual machines;

storing, in initial storage circuitry, data pages belonging to the one or more confidential virtual machines;

causing, by management circuitry, a migration of a migrating confidential virtual machine of the confidential virtual machines to subsequent processing circuitry so that a future execution of those of the program instructions associated with the migrating confidential virtual machine are executed by the subsequent processing circuitry instead of the initial processing circuitry, wherein the migration causes one of the data pages belonging to the migrating confidential virtual machine to be migrated from the initial storage circuitry to subsequent storage circuitry; and

accessing, by confidential access circuitry, the data pages belonging to the migrating confidential virtual machine to determine the one of the data pages, wherein

the data pages are unreadable by the management circuitry.

18. A system comprising:

the data processing apparatus of any one of clauses 1-16 implemented in at least one packaged chip;

at least one system component; and

a board, wherein

the at least one packaged chip and the at least one system component are assembled on the board.

19. A chip-containing product comprising the system of clause 18, wherein

the system is assembled on a further board with at least one other product component.

20. A non-transitory computer readable medium comprising a computer program configured, when executed by a computer to:

access data pages belonging to a migrating confidential virtual machine to determine one of the data pages to be migrated from an initial storage circuitry to a subsequent storage circuitry so that the migrating confidential virtual machine can be executed on a subsequent processing circuitry instead of an initial processing circuitry;

notify management circuitry of the one of the data pages to be migrated from an initial storage circuitry to a subsequent storage circuitry, wherein

the one of the data pages is unreadable by the management circuitry.

In the present application, the words “configured to…” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

Although illustrative embodiments of the invention have been described in detail herein with reference to the accompanying drawings, it is to be understood that the invention is not limited to those precise embodiments, and that various changes, additions and modifications can be effected therein by one skilled in the art without departing from the scope and spirit of the invention as defined by the appended claims. For example, various combinations of the features of the dependent claims could be made with the features of the independent claims without departing from the scope of the present invention.

We claim:

1. A data processing apparatus comprising:
initial processing circuitry configured to execute program instructions, wherein each of the program instructions relate to one or more confidential virtual machines;
initial storage circuitry configured to store data pages belonging to the one or more confidential virtual machines;
management circuitry configured to cause a migration of a migrating confidential virtual machine of the confidential virtual machines to subsequent processing circuitry so that a future execution of those of the program instructions associated with the migrating confidential virtual machine are executed by the subsequent processing circuitry instead of the initial processing circuitry, wherein the management circuitry is configured to cause the migration by causing one of the data pages belonging to the migrating confidential virtual machine to be migrated from the initial storage circuitry to subsequent storage circuitry; and
confidential access circuitry configured to access the data pages belonging to the migrating confidential virtual machine to determine the one of the data pages, wherein
the data pages are unreadable by the management circuitry.

2. The data processing apparatus according to claim 1, wherein
the management circuitry is configured to allocate the data pages to each of the confidential virtual machines.

3. The data processing apparatus according to claim 1, comprising:
tracking circuitry configured to track which of the data pages has been prepared for migration to the subsequent storage circuitry and in response to the one of the data pages being changed after being prepared for migration, to cause an invalidation notification to be sent to the subsequent storage circuitry that the one of the data pages should be invalidated.

4. The data processing apparatus according to claim 3, wherein
the management circuitry comprises the tracking circuitry, and the management circuitry updates the tracking circuitry in response to a change notification from the confidential access circuitry.

5. The data processing apparatus according to claim 3, wherein
the confidential access circuitry comprises the tracking circuitry and the invalidation notification is sent by requesting the management circuitry to send the invalidation notification.

6. The data processing apparatus according to claim 1, wherein
in response to a determination that one or more criteria regarding migrating of the data pages belonging to the migrating confidential virtual machine from the initial storage circuitry to the subsequent storage circuitry have been met, the management circuitry is configured to shut down the migrating confidential virtual machine and then to transfer remaining data pages belonging to the migrating confidential virtual machine to the subsequent storage circuitry.

7. The data processing apparatus according to claim 6, wherein
the determination is made by the management circuitry.

8. The data processing apparatus according to claim 6, wherein
the determination is made by the confidential access circuitry.

9. The data processing apparatus according to claim 6, wherein
the criteria comprise a number of those of the data pages belonging to the migrating confidential virtual machine that are changed after being prepared for migration to the subsequent storage circuitry.

10. The data processing apparatus according to claim 6, wherein
the criteria comprise a rate at which the number of those of the data pages belonging to the migrating confidential virtual machine that are changed after being prepared for migration to the subsequent storage circuitry, compared to a threshold.

11. The data processing apparatus according to claim 1, wherein
the confidential access circuitry comprises confidential virtual machine management circuitry configured to manage a behaviour of the confidential virtual machines.

12. The data processing apparatus according to claim 11, wherein
the confidential access circuitry comprises acceleration circuitry configured to determine the one of the data pages by reading the one of the data pages.

13. The data processing apparatus according to claim 12, wherein
the confidential virtual machine management circuitry is configured to perform an attestation process to determine an authenticity of the acceleration circuitry.

14. The data processing apparatus according to claim 12, wherein
the confidential virtual machine management circuitry is configured to respond to an attestation request from the acceleration circuitry by performing an attestation process on the confidential virtual machine management circuitry.

15. The data processing apparatus according to claim 12, wherein
at least one of the confidential virtual machine management circuitry and the acceleration circuitry is configured to perform an attestation process on the subsequent processing circuitry or a subsequent data processing apparatus comprising the subsequent processing circuitry.

16. The data processing apparatus according to claim 1, wherein
the confidential access circuitry is configured to perform an attestation process on the subsequent processing circuitry or a subsequent data processing apparatus comprising the subsequent processing circuitry.

17. A data processing method comprising:
executing program instructions, wherein each of the program instructions relate to one or more confidential virtual machines;
storing, in initial storage circuitry, data pages belonging to the one or more confidential virtual machines;
causing, by management circuitry, a migration of a migrating confidential virtual machine of the confidential virtual machines to subsequent processing circuitry so that a future execution of those of the program instructions associated with the migrating confidential virtual machine are executed by the subsequent processing circuitry instead of the initial processing circuitry, wherein the migration causes one of the data pages belonging to the migrating confidential virtual machine to be migrated from the initial storage circuitry to subsequent storage circuitry; and
accessing, by confidential access circuitry, the data pages belonging to the migrating confidential virtual machine to determine the one of the data pages, wherein
the data pages are unreadable by the management circuitry.

18. A system comprising:
the data processing apparatus of claim 1 implemented in at least one packaged chip;
at least one system component; and
a board, wherein
the at least one packaged chip and the at least one system component are assembled on the board.

19. A chip-containing product comprising the system of claim 18, wherein
the system is assembled on a further board with at least one other product component.

20. A non-transitory computer readable medium comprising a computer program configured, when executed by a computer to:
access data pages belonging to a migrating confidential virtual machine to determine one of the data pages to be migrated from an initial storage circuitry to a subsequent storage circuitry so that the migrating confidential virtual machine can be executed on a subsequent processing circuitry instead of an initial processing circuitry;
notify management circuitry of the one of the data pages to be migrated from an initial storage circuitry to a subsequent storage circuitry, wherein
the one of the data pages is unreadable by the management circuitry.
